(19) United States
(12) Patent Application Publication
(10) Pub. No.: US 2011/0000432 A1
(43) Pub. Date: Jan. 6, 2011

(54) One atmospheric pressure non-thermal plasma reactor with dual discharging-electrode structure

(75) Inventors: Shiaw-Huei Chen, Yonghe City (TW); Jyh-Ming Yan, Lujhu Township (TW); Yung-Chih Chen, Taipei City (TW); Men-Han Huang, Dasi Township (TW); Ming-Song Yang, Taipei City (TW)

Correspondence Address: Jackson Intellectual Property Group PLLC, 106 Starvale Lane, Shipman, VA, 22971, US

(73) Assignee: ATOMIC ENERGY COUNCIL - INSTITUTE OF NUCLEAR ENERGY RESEARCH, Taoyuan (TW)

(21) Appl. No.: 12/138,196

(22) Filed: Jun. 12, 2008

(51) Int. Cl. B01J 19/08

(52) U.S. Cl. 118/723 E

(57) ABSTRACT

A non-thermal plasma reactor includes a reactor chamber, a first electrode unit disposed in the top portion of chamber and a second electrode unit disposed in the bottom of the chamber, so that a plasma treatment region is defined between the first and second electrode units. The first electrode unit includes at least one or arrays of dual discharging-electrode structure embedded in an isolating layer. A high-voltage power supply is connected to the first and second electrode units. An external gas introducing unit is used to allow auxiliary gas into the plasma reaction region so that arrays of dual discharging-electrode structure can enhance the gas discharge process and thus promote the plasma assisted chemical reaction for cleaning purpose.

### FIELD OF THE INVENTION

The present invention relates to a plasma reactor that can be operated at one atmospheric pressure and above, also more particularly, it refers to a non-thermal plasma reactor with at least one special unit of dual discharging-electrode structure in its conducting electrode, and collective operation of these units embedded can be in configuration of series and/or parallel arrays and in staggered arrangement too, the overall function is to improve on the overall treatment efficiency for the purpose of waste gas cleaning, material surface cleaning and decontamination.

### DESCRIPTION OF THE RELATED ARTS

A typical non-thermal plasma reactor generally includes two conducting electrodes that are connected to a high voltage source which can enable gas break-down, thus an electrical discharge occurs between the two electrodes to generate plasma consisted of highly active particles such as excited atoms and molecules, free radicals.

In reality, dielectric barrier discharge (“DBD”) plasma reactor, that has been exploited widely, includes at least one isolating dielectric layer between two conducting electrodes. The spaces between the isolating layer and each of the electrodes are where the plasma generation and subsequent plasma assisted chemical reactions took place. High voltage electrical breakdown discharge in gas thus generates plasma in the reaction spaces mentioned above. Gaseous waste and/or the contaminated objects can be introduced into one of the reaction space for decontamination and cleaning purpose. The DBD plasma reactor produces highly energetic electrons by high voltage breakdown discharge in specific gas or in air through partial ionization, and can work under the atmospheric pressure. Therefore, it can be said to be an atmospheric non-thermal plasma reactor. However, The DBD plasma reactor is to be efficient in energy when compares with traditional thermal reactors that would be required to heat up the whole gas treatment space to high temperature for effectively thermal destruction. However in practice, the DBD plasma reactor still consumes much electricity that increases the total operational cost of the plasma abatement device.

To tackle the foregoing problem, a packed-bed plasma reactor is disclosed in U.S. Pat. No. 5,609,739. The packed-bed plasma reactor is made up usually from packing many small isolating beads with high dielectric coefficients to fill the reaction space between two electrodes. The dielectric beads can also be coated with catalyst. The packed-bed plasma reactor is intended to use the dielectric beads of high dielectric coefficients to promote the high electric field effect to ease the breakdown voltage which in term reduce the electricity, and the function of the catalyst can also help to enhance the chemical reaction and suppress the formation of hazardous by-products. The packed bed however interferes with the air flow and causes a large pressure drop so that the processing rate is low in practice. Moreover, the catalyst must be heated to its operating temperature usually, and this heating requires much extra-energy and might bring up the cost and complex the operating procedure.

Alternatively, J. S. Chang (J Phys. D: Appl. Phys. 32, 1999) proposed a stabilized flow plasma reactor to clean gaseous waste such as SO₂ and NOₓ. Plasma is used to improve the efficiency of selective catalytic reduction in which ammonia, NH₃, is used for desulphurization and deNOx processes, where ammonia is provided through an aperture at the end of a small pipe with a high DC voltage applied on it. Based on the principle of point discharge, the ammonia is ionized into highly active amino ions to expedite the oxidation of the sulfide and nitride. The stabilized flow plasma reactor can work at a low temperature and without the need to use catalyst. Hence, it consumes a little energy and involves a low cost. It is however not without any problem. The gaseous waste is not activated and is not evenly mixed with the amino ions. Hence, in practice an excessive amount of ammonia is being provided to increase the processing capacity and removal efficiency. There exists a risk of ammonia leakage which is a nuisance to the surrounding environment.

The present invention is therefore intended to obviate or at least alleviate the problems encountered in prior art.

### SUMMARY OF THE INVENTION

The primary objective of the present invention is to provide a plasma reactor that can be operated at one atmospheric pressure and above, also more particularly, it refers to a non-thermal plasma reactor with units of dual discharging-electrode structure embedded. Collective operation of these units embedded in this reactor can be in configuration on series and parallel arrays and in staggered arrangement too. This special designed dual discharging-electrode structure is in a form of tube-like shape with a small hollow needle electrode in the center. Auxiliary gas can be applied through this hollow channel and being ionized or excited by the applied high voltage, and the surrounding tube-like electrode can also be operated in discharge mode simultaneously to generate plasma consisted of highly active particles such as excited atoms and molecules, free radicals etc. These highly reactive species can thus promote the plasma chemical actions needed or desired. Due to the combination effect of dual discharging-electrode structure, the overall treatment efficiency is then enhanced for the purpose of waste gas cleaning, material surface cleaning and decontamination.

According to the present invention, the non-thermal plasma reactor includes a reactor chamber with two conducting electrode units located on the top and bottom section, where the first electrode unit with dual discharging-electrode structure is located on the top portion of the chamber and the second electrode unit is located in the bottom portion of the chamber, so that a plasma treatment region is defined as the space between the first and second electrode units. A high-voltage power supply is provided and connected to the first and second conducting electrode units for the purpose of gas breakdown and plasma generation. An external gas introducing unit disposed between cover plate of the reactor chamber and the first electrode unit for introducing auxiliary gas into the plasma treatment region.

An array of specific dual discharging-electrode structures are fabricated on the first electrode unit which is usually connected to a high voltage. This special-designed dual discharging-electrode structure is in a form of tube-like shape with hollow needle metal electrode located in the center of the surrounding tube-like metal electrode. An external gas introducing unit is used to introduce auxiliary gas through the small hollow needle pipe channels embedded in the first electrode unit into the plasma treatment region, so that the auxiliary gas is being first ionized through the enhanced ionization of needle-point discharge action when passing the needle-like nozzle, and the auxiliary gas can be further activated and excited again through interaction with the second surrounding tube-like electrode that is operated in discharge mode simultaneously. Also the external waste gas and decontaminated surface passed and/or placed inside the plasma treatment region can interact with highly active plasma generated by the auxiliary gas through this dual discharging-electrode structure.

Other objectives, advantages and features of the present invention will become apparent from the following description referring to the attached drawings.

### BRIEF DESCRIPTION OF THE DRAWINGS

The present invention will be described via the detailed illustration of the preferred embodiment referring to the drawings.

FIG. 1 is a cut-away view of a plasma reactor according to the preferred embodiment of the present invention.

FIG. 2 is a cross-sectional view of the plasma reactor shown in FIG. 1.

FIG. 3 is a cross-sectional view of the plasma reactor shown in FIG. 1 used to clean gaseous waste and contaminated surface.

### DETAILED DESCRIPTION OF EMBODIMENT

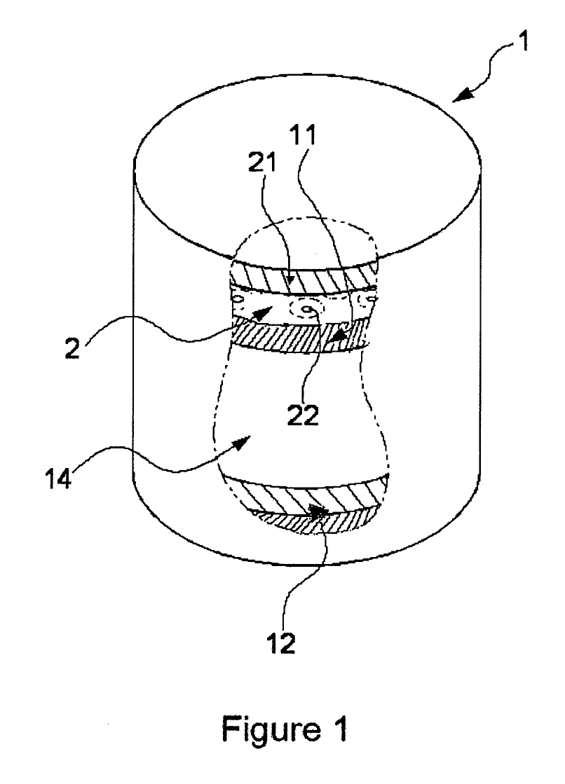

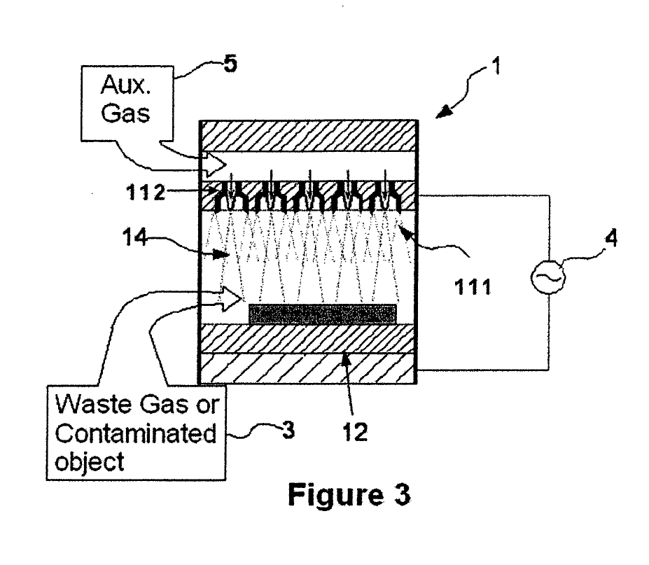

Referring to FIG. 1, a non-thermal plasma reactor includes a reactor chamber 1 and an external gas introducing unit 2. The plasma working gas can be externally introduced into the region of plasma discharge area 14 in chamber 1. The external gas introducing unit 2 is adapted to introduce auxiliary gas 5 into the chamber 1 to help and enhance the plasma assisted chemical reaction for cleaning purpose. In the reactor chamber 1, plasma can be generated to clean gaseous waste or the surface of contaminated objects 3 (FIG. 3).

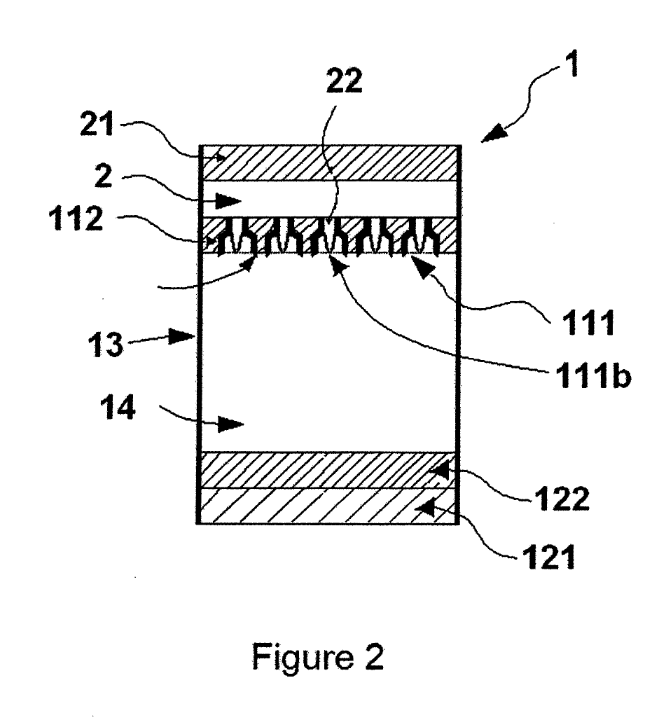

A first electrode unit 11 and a second electrode unit 12 are disposed in the chamber 1, located opposite to each other on top and bottom parts of the reactor chamber 1, respectively. Usually an isolating dielectric layer 122 is required and placed between the electrode units 11 and 12 for a DBD reactor, and in FIG. 2 it is located above the second conducting electrode 121. A support structure 13 is used to physically separate the two electrode units 11 and 12, and can also serve a gas-sealed wall for reactor chamber. The plasma treatment region 14, i.e. where the plasma generation and plasma assisted chemical reaction take place, is then defined as the space between first electrode unit 11 and dielectric layer 122.

The first electrode unit 11 includes at least one piece of dual-discharging electrode structures 111. Preferably, in practical operation for high volume, large surface, and speedy process, there are pluralities of this dual discharging-electrode structures 111 embedded inside the first electrode unit 11, and collective operation of these units embedded can be in configuration of series and/or parallel arrays and in staggered arrangement too. These dual discharging-electrode structures 111 are preferably made of metal with good conductivity, such as copper, stainless steel etc. These arrays of dual discharging-electrode structures 111 are isolated from one another and embedded in an isolating plate layer 112 with proper thickness, for example like 5˜20 mm. Each of the dual discharging-electrode structures 111 includes a surrounding tube-like metal cover structure 111a and a small hollow metal tube with needle-like structure 111b placed in the center of the surrounding metal cover structure 111a. The center needle-like structure 111b is shaped like a hollow sharp point to promote point discharge characteristic, the surrounding metal cover structure 111a is also with a sharp edge and can be in a shape like a tube, bell or cone etc.; and thus the special dual discharging-electrode structures 111 can efficiently generate plasma while saving energy. An auxiliary gas passageway 22 is referred to the small hollow metal tube of needle-point like discharging structure 111b.

The second electrode unit 12 consists of a flat metal electrode 121 and an isolating plate 122 placed above the flat electrode 121 usually. Gaseous waste or objects with contaminated surface is introduced into the plasma treatment region 14 between the isolating plate 122 and dual discharging-electrode structures 111 for cleaning and decontamination purpose. The isolating plate 122 of second electrode unit 12 may be replaced with a dirty object to be cleaned by this plasma reactor if the dirty object is also made of electrical isolating material. The isolating plates 112 and 122 may be made from glass, quartz, ceramic, poly tetra fluoride, or polyethylene (PE) etc. The applied high voltage is determined according to the material properties and thickness of each of the isolating plates 112 and 122, also depend on the gap length between the conducting electrode units 11 and 12.

The external gas introducing unit 2 includes a top plate 21 as the cover plate of chamber 1, and for reason of safety it is often chosen to be made from electrical isolating materials. A gas-buffering space 20 is defined as the space available between the first electrode unit 11 and the isolating plate 21, and the purpose of the gas-buffering space 20 is to ensure a uniform distribution of auxiliary gas when passing the passageways 22 of the arrays of hollow center needle-like structure 111b. The auxiliary gas 5 is thus guided into the air-buffering space 20 from the exterior connection of the chamber 1. The auxiliary gas 5 goes into the plasma treatment region 14 from the air-buffering space 20 through the passageways 22.

Referring to FIG. 3, in operation, the gaseous waste 3 or dirty objects are disposed in the plasma treatment region 14. The working gas is introduced externally into the plasma treatment region 14. The working gas may be air for example. The auxiliary gas 5 can also be introduced into the plasma treatment region 14. The type of the auxiliary gas 5 to be adapted is determined according to the physical and chemical properties of the gaseous waste or type of the dirty object 3. The auxiliary gas 5 applied may be dry gas such as air, oxygen, nitrogen, helium, argon, ammonia and carbon-tetra fluoride or humid air etc., or mixture of the above mentioned gases.

Respectively two electrode units 11 and 12 are connected to a high-voltage power supply 4 to enable gas discharge and to generate the chemically active plasma in the plasma treatment region 14. The applied high-voltage power supply 4 may be a high-frequency alternating current power supply or a pulsed power supply. The sharp tip of the center hollow needle-like structure 111b inside the dual discharging-electrode structure 111 provides easy point discharge to ionize and excite the auxiliary gas 5. The surrounding metal cover structure 111a inside the dual discharging-electrode structures 111 provide a uniform circular discharge covering a large area to excite the gaseous waste 3 or the dirty objects. The two types of plasma are mixed with each other in the plasma reaction region 14 to increase the processing rate and help remove certain contaminants. In general this direct excitation consumes only a little electricity because the flow rate of the auxiliary gas 5 is much smaller than that of the gaseous waste 3.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A non-thermal plasma reactor comprising of:
a reactor chamber;
a first electrode unit disposed in the top portion of the reactor chamber, the first electrode unit comprising at least one dual discharging-electrode structure;
a second electrode unit disposed in bottom portion the chamber;
a plasma treatment region is defined as the space between the first and second electrode units;
a high-voltage power supply is connected to the first and second electrode units; and
an external gas introducing unit disposed between cover plate of the reactor chamber and the first electrode unit for introducing auxiliary gas into the plasma treatment region.

2. The non-thermal plasma reactor according to claim 1, wherein the first electrode unit can comprise arrays of dual discharging-electrode structures in series and/or parallel configuration.

3. The non-thermal plasma reactor according to claim 2, wherein the first electrode unit comprises an isolating plate in which arrays of dual discharging-electrode structures are embedded in and isolated from one another.

4. The non-thermal plasma reactor according to claim 3, wherein the dual discharging-electrode structures includes a surrounding tube-like metal cover structure and a small hollow metal tube with needle-like structure placed in the center of the surrounding metal cover structure.

5. The non-thermal plasma reactor according to claim 4, wherein surrounding tube-like metal cover structure is with a sharp edge and can be in a shape like a tube, bell or cone etc.

6. The non-thermal plasma reactor according to claim 4, wherein small hollow metal tube with needle-like structure comprising a passageway defined for transmitting the auxiliary gas.

7. The non-thermal plasma reactor according to claim 3, wherein the isolating plate is made of electrical isolating material such as A1203 ceramic, polytetrafluoride (PTFE), and polyethylene (PE) etc

8. The non-thermal plasma reactor according to claim 1, wherein the second electrode unit comprises a flat electrode and an isolating plate provided on the flat electrode.

9. The non-thermal plasma reactor according to claim 1, wherein the high-voltage power supply can be selected from a group consisting of a high-frequency alternating current power supply and a pulsed power supply.

10. The non-thermal plasma reactor according to claim 1, wherein an external gas introducing unit comprises an isolating plate located over the first electrode unit, thus defining an air-buffering space between the isolating plate and the first electrode unit so that the auxiliary gas goes into the plasma reaction region from the air-buffering space through the passageway as in claim 6.

11. The non-thermal plasma reactor according to claim 10, wherein the auxiliary gas is selected from a group consisting of dry gas such as air, oxygen, nitrogen, helium, argon, ammonia and carbon-tetra fluoride or humid air etc., or mixture of the above mentioned gases.
